(19) United States
(12) Patent Application Publication
(10) Pub. No.: US 2007/0035232 A1
(43) Pub. Date: Feb. 15, 2007

(54) Electron emission display device

(76) Inventors: Sang-Ho Jeon, Yongin-si (KR); Chun-Gyoo Lee, Yongin-si (KR); Sang-Jo Lee, Yongin-si (KR); Sang-Hyuck Ahn, Yongin-si (KR); Su-Bong Hong, Yongin-si (KR)

Correspondence Address: CHRISTIE, PARKER & HALE, LLP, PO BOX 7068, PASADENA, CA, 91109-7068, US

(21) Appl. No.: 11/499,429

(22) Filed: Aug. 4, 2006

(30) Foreign Application Priority Data
Aug. 11, 2005 (KR) 10-2005-0073773

(51) Int. Cl. H01J 63/04; H01J 1/62

(52) U.S. Cl. 313/496

(57) ABSTRACT

An electron emission display device capable of achieving a high efficiency. In one embodiment, the electron emission display device includes a first substrate, a second substrate facing the first substrate, an electron emission unit formed on the first substrate, and a light emission unit having a phosphor layer patterned on the second substrate. In this embodiment, when an area of an electron beam spot of an electron beam emitted from the electron emission unit and landed on the phosphor layer is indicated by A, and an area of the phosphor layer corresponding to the electron beam spot is indicated by B, the areas A and B satisfy: 0.9≦A/B≦1.4.

### CROSS-REFERENCE TO RELATED APPLICATION

This application claims priority to and the benefit of Korean Patent Application 10-2005-0073773, filed in the Korean Intellectual Property Office on Aug. 11, 2005, the entire content of which is incorporated herein by reference.

### BACKGROUND OF THE INVENTION

1. Field of the Invention

The present invention relates to an electron emission display device, and in particular, to an electron emission display device having a high efficiency.

2. Description of Related Art

An electron emission device (e.g., a field emitter array (FEA) type emission device, a surface conduction emission (SCE) type emission device, a metal-insulator-metal (MIM) type emission device, and a metal-insulator-semiconductor (MIS) type emission device, etc.) may be used in an electron emission display device which displays the desired images using the electrons emitted from the electron emission regions of the electron emission device.

The electron emission display device includes first and second substrates for forming a vacuum chamber (or vessel), an electron emission structure provided on the first substrate, and phosphor layers formed on the second substrate together with an anode electrode for effectively accelerating the electrons emitted from the electron emission regions toward the phosphor layers.

The electrons emitted from the electron emission regions land on the second substrate (more specifically on the phosphor layers) in the form of electron beam spots. The area of each electron beam spot on the second substrate is controlled to minimize (or reduce or prevent) the light emission of incorrect color phosphor layers. If the area of the electron beam spot is controlled by only considering the light emission of the incorrect color phosphor layers, the outer boundary of a correct phosphor layer may be so enlarged that even a wide area beam spot may be used, but an intensity of the collision maybe so weaken by the enlargement that certain portions of the correct phosphor layer may not emit enough light. Accordingly, the amount of electric current that are actually used to emit light may be reduced so that the luminance and the light emission efficiency may be deteriorated. Further, the area ratio of the electron beam spot to the phosphor layer influences the uniformity in the light emission.

As the area ratio of the electron beam spot to the phosphor layer influences the luminance, the light emission efficiency, and the light emission uniformity of the electron emission display device, the area ratio should be controlled considering these factors.

### SUMMARY OF THE INVENTION

An aspect of the present invention provides an electron emission display device which controls the area ratio of the electron beam spot to the corresponding phosphor layer.

In one embodiment of the present invention, an electron emission display device includes a first substrate, a second substrate facing the first substrate, an electron emission unit formed on the first substrate, and a light emission unit having a phosphor layer patterned on the second substrate. In this embodiment, when an area of an electron beam spot of an electron beam emitted from the electron emission unit and landed on the phosphor layer is indicated by A, and an area of the phosphor layer corresponding to the electron beam spot is indicated by B, the areas A and B satisfy: 0.9≦A/B≦1.4.

In one embodiment, when a central width of the electron beam spot is indicated by AW, and a central width of a portion of the phosphor layer corresponding to the electron beam spot is indicated by BW, the widths AW and BW satisfy: 0.95≦AW/BW≦1.4.

In one embodiment, when a central length of the electron beam spot is indicated by AH, and a central length of a portion of the phosphor layer corresponding to the electron beam spot is indicated by BH, the lengths AH and BH satisfy: 0.95≦AH/BH≦1.2.

In one embodiment, the phosphor layer includes a plurality of phosphor layers and the electron beam spot includes a plurality of beam spots, and the phosphor layers are separately formed to correspond to the respective electron beam spots.

With one or more of the above embodiments, an area ratio of the electron beam spot to the phosphor layer is controlled so that the phosphor layer is more effectively excited to emit light even with the same amount of electric current, and the luminance is enhanced. Accordingly, the light emission efficiency of an electron emission display device defined by the ratio of the luminance to the power consumption is heightened.

Furthermore, with the control of the area ratio of the electron beam spot to the phosphor layer, the light emission uniformity is heightened, and as a result, the display characteristic of the electron emission display device is further enhanced.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial exploded perspective view of an electron emission display device according to an embodiment of the present invention;

FIG. 2 is a partial sectional view of the electron emission display device according to the embodiment of the present invention;

FIG. 3 is a partial plan view of the electron emission display device according to the embodiment of the present invention, schematically illustrating a second substrate with phosphor layers and a black layer, and electron beam spots landed thereon; and

FIG. 4 is a graph illustrating the light emission efficiency of the electron emission display device as function of a value A/B.

### DETAILED DESCRIPTION

In the following detailed description, certain embodiments of the present invention are shown and described, by way of illustration. As those skilled in the art would recognize, the described embodiments may be modified in various ways, all without departing from the spirit or scope of the present invention. Accordingly, the drawings and description are to be regarded as illustrative in nature, rather than restrictive.

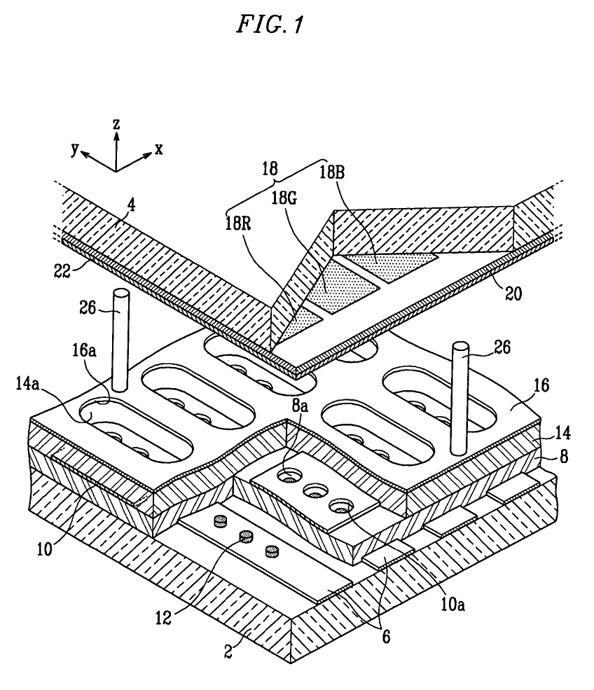

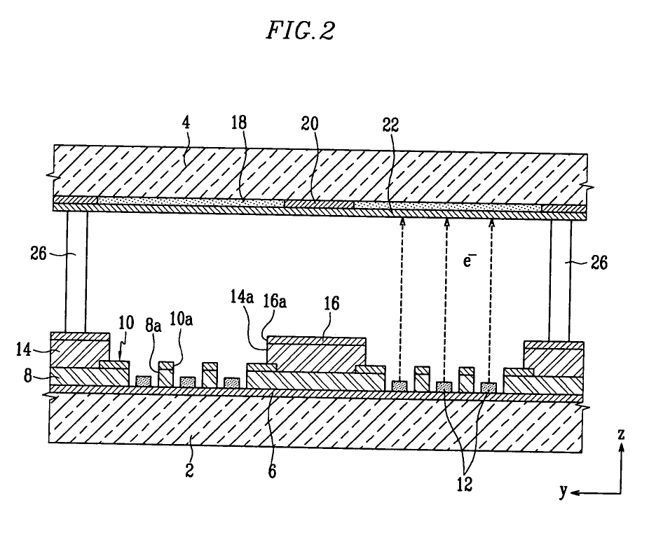

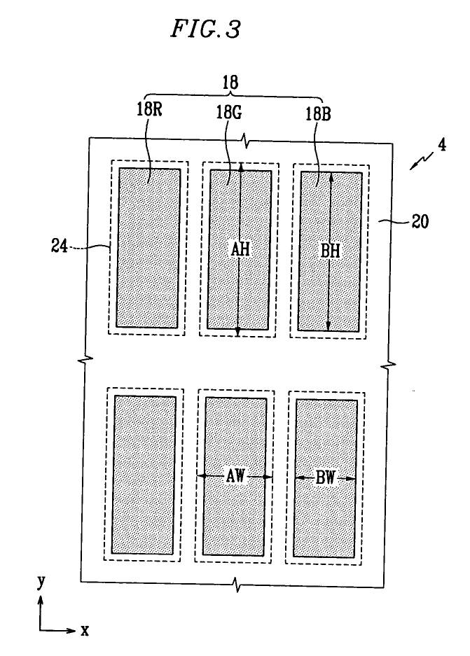

FIG. 1 is a partial exploded perspective view of an electron emission display device according to an embodiment of the present invention, and FIG. 2 is a partial sectional view of the electron emission display device according to the embodiment of the present invention. FIG. 3 is a partial plan view of the electron emission display device according to the embodiment of the present invention, schematically illustrating a second substrate with phosphor layers and a black layer and electron beam spots landed thereon.

As shown in FIGS. 1, 2, and 3, the electron emission display device includes first and second substrates 2 and 4 arranged parallel with each other with an inner space therebetween. An electron emission structure (electron emission units) is provided on the first substrate 2, and a light emission structure (light emission units) is provided on the second substrate 4 to emit visible light rays due to the electrons to thereby display an image.

Specifically, cathode electrodes (or first electrodes) 6 are stripe-patterned on the first substrate 2 in a direction of the first substrate 2 (in the direction of the y axis of FIGS. 1, 2, and 3), and a first insulating layer 8 is formed on the entire surface of the first substrate 2 while covering the cathode electrodes 6. Gate electrodes (or second electrodes) 10 are stripe-patterned on the first insulating layer 8 crossing (or perpendicular to) the cathode electrodes 6 (in the direction of the x axis of FIGS. 1 and 3).

In this embodiment, one or more electron emission regions 12 are formed on the cathode electrodes 6 at the cross regions of the cathode and gate electrodes 6 and 10. Opening portions 8a and 10a are respectively formed at the first insulating layer 8 and the gate electrodes 10 corresponding to the respective electron emission regions 12 to expose the electron emission regions 12 on the first substrate 2.

The electron emission regions 12 are formed with a material for emitting electrons under the application of an electric field. In one embodiment, the material is a carbonaceous material and/or a nanometer-sized material. In one embodiment, the electron emission regions 12 are formed with carbon nanotube, graphite, graphite nanofiber, diamond, diamond-like carbon, C₆₀, silicon nanowire or a combination thereof. The electron emission regions 12 may be formed through screen printing, direct growth, chemical vapor deposition, and/or sputtering.

It is illustrated in FIGS. 1, 2, and 3 that the electron emission regions 12 are formed in the shape of a circle, and are linearly arranged at the cross regions of the cathode and gate electrodes 6 and 10 in a longitudinal direction of the cathode electrodes 6. However, the shape, the number, and/or the arrangement of the electron emission regions 12 are not limited to the embodiment shown in FIGS. 1, 2, and 3, and may be altered in various suitable manners.

Further, it is explained above that the gate electrodes 10 are placed over the cathode electrodes 6 while interposing the first insulating layer 8 therebetween. However, cathode electrodes may alternatively be placed over the gate electrodes with an insulating layer therebetween. In this alternative case, an electron emission region may contact the lateral side of a respective one of the cathode electrodes on the insulating layer.

Referring back to FIGS. 1, 2, and 3, a second insulating layer 14 and a focusing electrode 16 are formed on the gate electrodes 10 and the first insulating layer 8. Opening portions 14a and 16a are also respectively formed at the second insulating layer 14 and the focusing electrode 16 to pass the electron beams. For instance, the opening portions 14a and 16a are provided to correspond to the respective cross regions of the cathode and gate electrodes 6 and 10 in a one-to-one manner to collectively focus the emitted electrons. The greater the difference in height between the focusing electrode 16 and the electron emission regions 12 is, the more highly exerted the focusing effect becomes. Therefore, in one embodiment, the thickness of the second insulating layer 14 is established to be thicker (or greater) than that of the first insulating layer 8.

The focusing electrode 16 is formed on the entire surface of the first substrate 2. Furthermore, the focusing electrode 16 may be formed with a conductive film coated on the second insulating layer 14, or a metallic plate with opening portions 16a.

Phosphor layers 18 with red, green and blue phosphor layers 18R, 18G and 18B are formed on a surface of the second substrate 4 facing the first substrate 2 while being spaced apart from each other with a distance therebetween. A black layer 20 is formed between the respective phosphor layers 18 to enhance the screen contrast.

It is illustrated in FIGS. 1, 2, and 3 that the phosphor layers 18 are placed to correspond to the cross regions of the cathode and gate electrodes 6 and 10 in a one-to-one manner, and the black layer 20 is formed on the entire non-light emission area except for the area of the phosphor layers 18. However, the present invention is not limited thereto, and the phosphor layers and the black layer may be patterned with various suitable shapes such as a stripe shape.

An anode electrode 22 is formed on the phosphor layers 18 and the black layer 20 with a metallic material, such as aluminum. The anode electrode 22 receives a high voltage required for accelerating the electron beams from the electron emission regions 12, and reflects the visible rays radiated from the phosphor layers 18 to the first substrate 2 toward the second substrate 4, thereby heightening the screen luminance.

Alternatively, an anode electrode may be formed with a transparent conductive material such as indium tin oxide (ITO), instead of the metallic material. In this alternative case, the anode electrode is placed on a surface of the phosphor layers and the black layer directed toward the second substrate (i.e., the anode electrode is between the second substrate and the phosphor layers), and patterned with a plurality of portions.

Spacers 26 are arranged between the first and second substrates 2 and 4, which are sealed with each other at their peripheries using a sealing member such as glass frit. The inner space between the first and second substrates 2 and 4 is exhausted to be in a vacuum state (or to form a vacuum), thereby constructing an electron emission display device. The spacers 26 are arranged at the non-light emission area where the black layer 20 is located.

In order to drive the above-structured electron emission display device, voltages (which may be predetermined) are applied to the cathode electrodes 6, the gate electrodes 10, the focusing electrode 16, and the anode electrode 22. For instance, a scanning signal voltage is applied to the cathode electrodes 10 (or the gate electrodes 6), and a data signal voltage is applied to the gate electrodes 6 (or the cathode electrodes 10). A negative (−) direct current voltage from several to several tens of volts is applied to the focusing electrode 16, and a positive (+) direct current voltage from several hundreds to several thousands of volts is applied to the anode electrode 22.

When the voltage difference between the cathode and gate electrodes 6 and 10 exceeds the threshold value, an electric field is formed around an electron emission region 12, and electrons e⁻ are emitted from the electron emission region 12. The emitted electrons are focused by a repulsive force while passing through the focusing electrode 16. The electrons are then attracted by the high voltage applied to the anode electrode 22 to collide with (or land on) a phosphor layer 18 in the form of an electron beam spot 24.

The electron beam spot 24 refers to the electron beam that had landed on the phosphor layer 18 and the black layer 20 positioned adjacent thereto.

In this embodiment, an area A of an electron beam spot 24 landed on the phosphor layer 18, and an area B of the phosphor layer 18 corresponding to the electron beam spot 24 having certain dimensions, which may have been optimized. The area B of the phosphor layer 18 corresponding to the electron beam spot 24 indicates the area of the portion of the phosphor layer 18 formed such that it corresponds to the electron beam spot 24 to be landed thereon.

In this embodiment, as the phosphor layers 18 are separately formed to correspond to the respective cross regions of the cathode and gate electrodes 6 and 10, the area of the phosphor layer 18 corresponding to the electron beam spot 24 corresponds to the area of the phosphor layer 18. The area of the phosphor layer corresponding to the electron beam spot is differentiated depending upon the arrangement and shape of the phosphor layers, and the present invention is not limited thereto.

In this embodiment, an area A of an electron beam spot 24, and an area B of a phosphor layer 18 corresponding thereto are established to satisfy the following ratio range 1:
0.9≦A/B≦1.4 (1)

When the value A/B is less than 0.9, the landing area of the electron beam spot 24 in the overall area of the phosphor layer 18 is so reduced that the area of the phosphor layer 18 used to emit light is reduced. That is, a large portion of the phosphor layer 18 does not emit visible lights, and the area of the electron beam spot 24 is so reduced that the light emission uniformity is also deteriorated.

When the value A/B exceeds 1.4, the area of the electron beam spot 24 is so enlarged that the amount of electrons landing on the phosphor layer 18 is reduced (i.e., the intensity of the electron beam is reduced), thereby deteriorating the luminance.

Accordingly, the value A/B is established to be in the range from 0.9 to 1.4 such that the luminance of the electron emission display device is enhanced, and as a result, the efficiency defined by the ratio of the luminance to the power consumption is enhanced. Furthermore, the light emission uniformity is improved.

With the electron emission display device according to the present invention, various ways where the area of each electron beam spot 24 and the area of the phosphor layer 18 corresponding thereto satisfy the above condition may be introduced. For instance, the size of the openings of the focusing electrode 16 or the voltage applied to the focusing electrode 16 is controlled to thereby control the area of the respective electron beam spots 24. The shape and area of the phosphor layer 18 may be designed considering the area of the electron beam spot 24.

Furthermore, with the electron emission display device according to the present embodiment, a central length AH and a central width AW of an electron beam spot 24 are designed in consideration of a central length BH and a central width BW of the portion of a phosphor layer 18 corresponding to the electron beam spot 24.

The central length AH of the electron beam spot 24 is the longitudinal size (or long width) of the electron beam spot 24 measured on the center of the electron beam spot 24, and the central width AW of the electron beam spot 24 is the latitudinal size (or short width) of the electron beam spot 24 measured on the center of the electron beam spot 24. The central length BH of the phosphor layer 18 is the longitudinal size (or long width) of the phosphor layer 18 measured on the center of the portion of the phosphor layer 18 formed such that it corresponds to the electron beam spot 24 to be landed thereon, and the central width BW of the phosphor layer 18 is the latitudinal size (or short width) of the phosphor layer measured on the center of the portion of the phosphor layer 18 formed such that it corresponds to the electron beam spot 24 to be landed thereon.

In one embodiment of the invention, a ratio range of the central widths AW and BW and a ratio range of the central lengths AH and BH are established because even if the area A of the electron beam spot 24 and the area B of the phosphor layer 18 corresponding thereto satisfy the above described ratio range 1, the amount of electrons serving to excite the phosphor layer 18 may still be reduced when the difference between the central widths AW and BW is too great, and/or when the difference between the central lengths AH and BH is too great.

As such, a central width AW of an electron beam spot 24 and a central width BW of a phosphor layer 18 corresponding thereto are established to satisfy the following ratio range 2:
0.95≦AW/BW≦1.4 (2)

A central length AH of the electron beam spot 24 and a central length BH of the phosphor layer 18 are established to satisfy the following ratio 3:
0.95≦AH/BH≦1.2 (3)

When the values AW/BW and AH/BH are less than 0.95, the light emission uniformity may be deteriorated. By contrast, when the value AW/BW exceeds 1.4 or the value AH/BH exceeds 1.2, the amount of electrons serving to excite the phosphor layer 18 is reduced so that the luminance may be lowered. That is, such the ranges are determined by considering an enhancement in the light emission uniformity, the luminance, and the light emission efficiency.

When the conditions of the ratio ranges 2 and 3 are satisfied, the area A of the electron beam spot 24 and the area B of the phosphor layer 18 corresponding thereto may need to be separately established to satisfy the condition of the ratio rage 1. This is because as differentiated from FIGS. 1, 2, and 3, the shape of the electron beam spot 24 of certain embodiments of the invention may not be a rectangle.

Also, referring to FIGS. 1, 2, and 3, if the portion of the phosphor layer 18 corresponding to each electron beam spot 24 commonly has a rectangular structure, the central width AW of the electron beam spot 24 and the central width BW of the phosphor layer 18 influence the luminance substantially more than the central length AH of the electron beam spot 24 and the central length BH of the phosphor layer 18. In this connection, the value AW/BW and the value AH/BH are determined such that they differ from each other.

Certain embodiments of the present invention will now be explained in more detail with reference to certain examples. However, the examples only exemplify the present invention, and the invention is not thereby limited.

### EXAMPLES

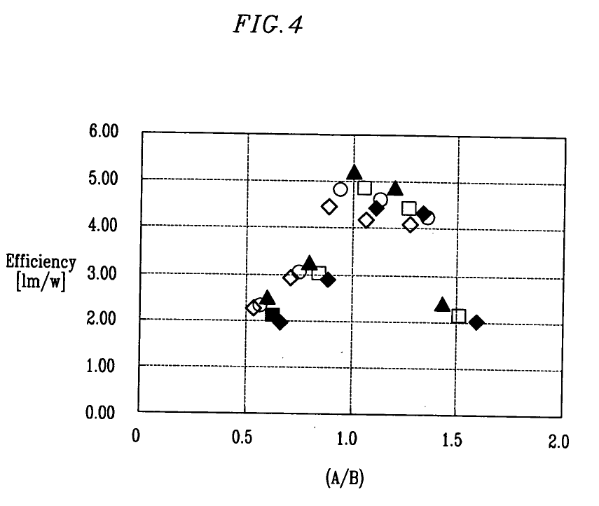

FIG. 4 is a graph illustrating the light emission efficiency as a function of the value A/B for several electron emission display devices.

As shown in FIG. 4, when the value A/B was in the range from 0.9 to 1.4, the light emission efficiency was higher, as compared to the cases when the value A/B was less than 0.9, or more than 1.4. That is, with the electron emission display device according to the embodiment of the present invention, the light emission efficiency can be enhanced by controlling the area of the electron beam spot and the area of the phosphor layer corresponding thereto.

In the following example, a rectangular-shaped phosphor layer with a central width BW of 150 μm and a central length BH of 450 μm was formed to correspond to the respective cross regions of the cathode and gate electrodes. The luminance and the light emission efficiency were measured while varying the central width AW of the electron beam spot to 120 μm, 150 μm, 180 μm, and 215 μm, and the measurement results are listed in Table 1. The central length AH of the electron beam spot was kept at 450 μm.

| | | | | Light emission |
|---|---|---|---|---|
| | | Value of | Luminance | efficiency |
| | AW (μm) | AW/BW | (lm) | (lm/W) |
| Ex. 1 | 150 | 1.000 | 252 | 5.21 |
| Ex. 2 | 180 | 1.200 | 236 | 4.88 |
| Com. Ex. 1 | 90 | 0.600 | 121 | 2.50 |
| Com. Ex. 2 | 120 | 0.800 | 157 | 3.24 |
| Com. Ex. 3 | 215 | 1.433 | 145 | 3.00 |

As listed in Table 1, each of the electron emission display devices according to Examples 1 and 2 where the value AW/BW was in the range from 0.95 to 1.4 had a higher luminance and a higher light emission efficiency, as compared to those of the electron emission display devices according to Comparative Examples 1, 2, and 3.

Rectangular-shaped phosphor layers each with a central width BW of 150 μm and a central length BH of 450 μm were formed on the second substrate at the locations corresponding to the respective cross regions of the cathode and gate electrodes. The luminance and the light emission efficiency were measured while varying the central length AH of the electron beam spot to 390 μm, 405 μm, 450 μm, 540 μm and 555 μm, and the measurement results are listed in Table 2. The central width AW of the electron beam spot was kept at 150 μm.

TABLE 2

| | | | | Light emission |
|---|---|---|---|---|
| | | | Luminance | efficiency |
| | AH (μm) | AH/BH | (lm) | (lm/W) |
| Ex. 3 | 450 | 1.000 | 252 | 5.21 |
| Ex. 4 | 540 | 1.200 | 230 | 4.80 |
| Com. Ex. 4 | 390 | 0.867 | 182 | 3.76 |
| Com. Ex. 5 | 405 | 0.900 | 203 | 4.19 |
| Com. Ex. 6 | 555 | 1.233 | 152 | 3.14 |

As listed in Table 2, each of the electron emission display devices according to Examples 3 and 4 where the value AH/BH was in the range from 0.95 to 1.2 had a higher luminance and a higher light emission efficiency, as compared to those of the electron emission display devices according to Comparative Examples 4, 5, and 6.

It is explained above that phosphor layers are separately formed to correspond to the respective cross regions of the cathode and gate electrodes, but the present invention is not limited thereto. That is, the phosphor layers may be stripe-patterned. In this case, the above-identified conditions should be met on the basis of the portion of the phosphor layer to be landed thereon with the electron beam spot.

Furthermore, the present invention is explained with respect to an FEA-type emission device where the electron emission regions are formed with a material for emitting electrons under the application of an electric field, but the present invention not limited thereto. That is, the inventive structure may be applied to other types of electron emission display devices in various suitable manners.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. An electron emission display device comprising:
a first substrate;
a second substrate facing the first substrate;
an electron emission unit formed on the first substrate; and
a light emission unit having a phosphor layer patterned on the second substrate;
wherein when an area of an electron beam spot of an electron beam emitted from the electron emission unit and landed on the phosphor layer is indicated by A, and an area of the phosphor layer corresponding to the electron beam spot is indicated by B, the areas A and B satisfy:
0.9≦A/B≦1.4.

2. The electron emission display device of claim 1, wherein when a central width of the electron beam spot is indicated by AW, and a central width of a portion of the phosphor layer corresponding to the electron beam spot is indicated by BW, the widths AW and BW satisfy:
0.95≦AW/BW≦1.4.

3. The electron emission display device of claim 1, wherein when a central length of the electron beam spot is indicated by AH, and a central length of a portion of the phosphor layer corresponding to the electron beam spot is indicated by BH, the lengths AH and BH satisfy:
0.95≦AH/BH≦1.2.

4. The electron emission display device of claim 1, wherein when a central width of the electron beam spot is indicated by AW, a central width of the portion of the phosphor layer corresponding to the electron beam spot is indicated by BW, a central length of the electron beam spot is indicated by AH, and a central length of the portion of the phosphor layer corresponding to the electron beam spot is indicated by BH, the widths AW and BW and the lengths AH and BH satisfy:
0.95≦AW/BW≦1.4, and 0.95≦AH/BH≦1.2.

5. The electron emission display device of claim 1, wherein the phosphor layer comprises a plurality of phosphor layers and the electron beam spot comprises a plurality of beam spots, and wherein the phosphor layers are separately formed to correspond to the respective electron beam spots.

6. The electron emission display device of claim 1, wherein the electron emission unit comprises a plurality of first electrodes and a plurality of second electrodes insulated from the first electrodes, and wherein the electron emission unit further comprises a plurality of electron emission regions electrically connected to the first electrodes.

7. The electron emission display device of claim 6, further comprising a focusing electrode formed over the first and second electrodes while being insulated from the first and second electrodes via an insulating layer, and having a plurality of opening portions for passing the electron beams.

8. The electron emission display device of claim 6, wherein the electron emission regions are formed with a material comprising carbon nanotube, graphite, graphite nanofiber, diamond, diamond-like carbon, C₆₀, and/or silicon nanowire.

9. An electron emission display device comprising:
a first substrate;
a second substrate facing the first substrate;
an electron emission unit formed on the first substrate; and
a light emission unit having a phosphor layer patterned on the second substrate;
wherein when a central width of an electron beam spot of an electron beam emitted from the electron emission unit and landed on the phosphor layer is indicated by AW, and a central width of a portion of the phosphor layer corresponding to the electron beam spot is indicated by BW, the widths AW and BW satisfy:
0.95≦AW/BW≦1.4.

10. The electron emission display device of claim 9, wherein when a central length of the electron beam spot is indicated by AH, and a central length of the portion of the phosphor layer corresponding to the electron beam spot is indicated by BH, the lengths AH and BH satisfy:
0.95≦AH/BH≦1.2.

11. The electron emission display device of claim 9, wherein when an area of the electron beam spot is indicated by A, and an area of the phosphor layer corresponding to the electron beam spot is indicated by B, the areas A and B satisfy:
0.9≦A/B≦1.4.

12. The electron emission display device of claim 11, wherein when a central length of the electron beam spot is indicated by AH, and a central length of the portion of the phosphor layer corresponding to the electron beam spot is indicated by BH, the lengths AH and BH satisfy:
0.95≦AH/BH≦1.2.

13. An electron emission display device comprising:
a first substrate;
a second substrate facing the first substrate;
an electron emission unit formed on the first substrate; and
a light emission unit having a phosphor layer patterned on the second substrate;
wherein when a central length of an electron beam spot of an electron beam emitted from the electron emission unit and landed on the phosphor layer is indicated by AH, and a central length of a portion of the phosphor layer corresponding to the electron beam spot is indicated by BH, the lengths AH and BH satisfy:
0.95≦AH/BH≦1.2.

14. The electron emission display device of claim 13, wherein when an area of the electron beam spot is indicated by A, and an area of the phosphor layer corresponding to the electron beam spot is indicated by B, the areas A and B satisfy:
0.9≦A/B≦1.4.
